(19) United States
(12) Patent Application Publication
(10) Pub. No.: US 2010/0243646 A1
(43) Pub. Date: Sep. 30, 2010

(54) METHOD AND APPARATUS FOR MODE STIRRING IN A MICROWAVE OVEN

(75) Inventors: John Erik Hershey, Ballston Lake, NY (US); Michael James Hartman, Clifton Park, NY (US); Kenneth Brakeley Welles, Scotia, NY (US); Richard Louis Zinser, Niskayuna, NY (US); John Anderson Fergus Ross, Niskayuna, NY (US)

Correspondence Address: GE TRADING & LICENSING, 1 RESEARCH CIRCLE, ATTN: BRANDON, K1 - 2A62A, NISKAYUNA, NY, 12309, US

(73) Assignee: GENERAL ELECTRIC COMPANY, Schenectady, NY (US)

(21) Appl. No.: 12/409,696

(22) Filed: Mar. 24, 2009

(51) Int. Cl. H05B 6/74

(52) U.S. Cl. 219/751

(57) ABSTRACT

In one embodiment, a method includes emitting electromagnetic radiation from a magnetron and receiving the electromagnetic radiation in a scatterer. The method also includes varying a radar cross section of the scatterer in response to exposure to the electromagnetic radiation.

### BACKGROUND OF THE INVENTION

The subject matter disclosed herein relates to microwave ovens, and, more specifically, to an electronic mode stirrer used to enable an improved distribution of wave patterns to cause even heating within such ovens.

In microwave ovens, cold spots or small spatial regions may occur, where heating is uneven or lesser than in other regions of the oven, due to a low density of signal energy. These cold spots are the result of multipath interference between wave patterns. Corresponding regions or volumes of food or other items placed at these cold spots may be underheated or undercooked as compared to other parts of the same food or items. Food is thus often turned or otherwise moved physically in microwave ovens. One other technique that may be used to reduce these effects of a multipath-induced heating deficiency is referred to as mode stirring. This technique can be performed in a variety of ways such as through incorporation of a moving reflector near the point where wave patterns are emitted. The moving reflector changes the standing wave patterns and spatially perturbs the nulls in the wave patterns. Mechanical mode stirring arrangements may, however, include a costly and noisy mechanical apparatus to drive the reflector. This mechanical system may entail extra manufacturing time and components in addition to moving parts that may require maintenance later in the life of the microwave oven.

### BRIEF DESCRIPTION OF THE INVENTION

The invention provides a system that includes a mode stirrer comprising a scatterer with a radar cross section. Further, the radar cross section is configured to change when exposed to electromagnetic waves to reduce a destructive interference condition within a structure where the electromagnetic waves are directed. A method is also provided that includes emitting electromagnetic waves from a magnetron and receiving the electromagnetic waves in a scatterer. The method also includes varying a radar cross section of the scatterer in response to exposure to the electromagnetic waves.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a sectional schematic diagram of a microwave oven and electronic mode stirrer in accordance with an embodiment of the invention;

FIG. 2 is a detailed schematic diagram of the electronic mode stirrer, along with a magnetron and mass, in accordance with an embodiment of the invention;

FIG. 3 is a detailed schematic diagram of the components included in an electronic mode stirrer in accordance with an embodiment of the invention;

FIG. 4 is a top view of an electronic mode stirrer system, in the form of a cooking platform, in accordance with an embodiment of the invention;

FIG. 5 is a top view of an electronic mode stirrer system, in the form of a piece of cookware, in accordance with an embodiment of the invention; and

FIG. 6 is a side view of the piece of cookware shown in FIG. 5 in accordance with an embodiment of the invention.

### DETAILED DESCRIPTION OF THE INVENTION

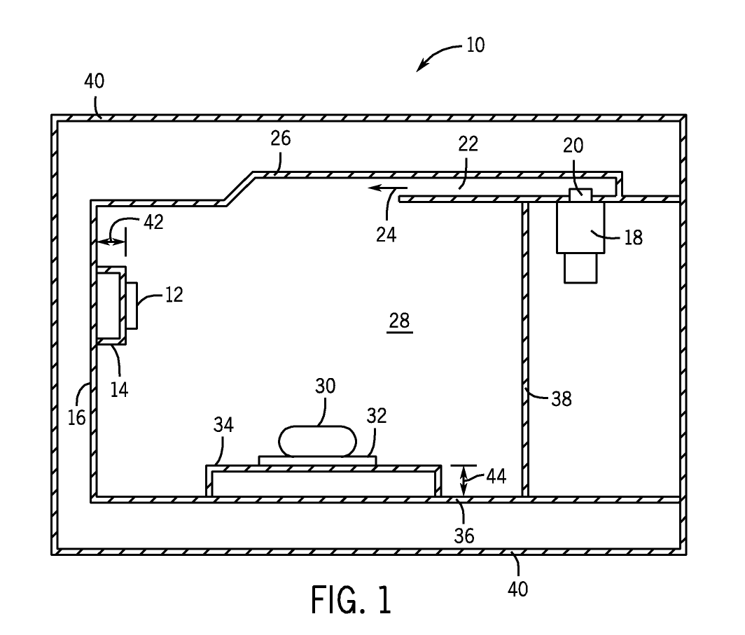

FIG. 1 is a sectional schematic view of an embodiment of a microwave system 10 that includes an electronic mode stirrer assembly 12. As depicted, the electronic mode stirrer assembly 12 enables an improved distribution of heating energy throughout the microwave system by perturbing microwave patterns to remove nulls or cold spots. The microwave system 10 also includes a bracket 14 which may be coupled to a wall 16. Further, the electronic mode stirrer assembly 12 may be located on or embedded in the bracket 14. For example, the electronic mode stirrer assembly 12 may be located on a sticker or decal that may be coupled to the bracket 14 via an adhesive. In the microwave system 10, a magnetron 18 generates electromagnetic waves, which are emitted from a feeder 20. After being emitted from the feeder 20, the electromagnetic waves travel through a wave guide 22 in a direction 24 within the microwave system 10. In addition, the electromagnetic waves may reflect off of members within the structure of the microwave system 10, including the wall 16 and a ceiling 26. Further, as the electromagnetic waves reflect off of structures within microwave system 10, a wave pattern may be established within the structure of a microwave cavity 28. Accordingly, cold spots or nulls within the cavity 28 may be reduced or eliminated by the electronic mode stirrer assembly 12, which is configured to disrupt wave patterns within the structure, thereby ensuring more even heating of a mass 30 (e.g., food) to be heated by the microwave system 10. The electronic mode stirrer assembly 12 is configured to perturb or disrupt the electromagnetic wave patterns within the cavity 28, in order to more evenly distribute the electromagnetic energy, thereby ensuring a more even cooking or heating of the mass 30.

In addition, the mass 30 may be placed upon or in a piece of cookware 32 or a tray. The cookware 32 or tray may be removed from the microwave system 10 following the heating of the mass 30 for reuse and cleaning. The piece of cookware 32 may be placed on a platform 34, which may be used elevate the mass 30 during a heating operation of the microwave system 10. In presently contemplated embodiments, the electronic mode stirrer assembly 12 may be located in or on a structure within the microwave, including the piece of cookware 32, the removable tray, or the platform 34. The platform 34 may be coupled to microwave oven floor 36. Alternatively, the electronic mode stirrer assembly 12 may be alternatively located on the wall 38 of the oven. Further, a plurality of electronic mode stirrer assemblies 12 may be located throughout the structure of the microwave system 10 inside the microwave cavity 28. Specifically, an electronic mode stirrer assembly 12 may be coupled to the wall 16, the wall 38, the ceiling 26, the floor 36 and/or structures coupled to these surfaces. The electronic mode stirrer assembly 12 may be located on brackets 14 and/or platform 34 in order to more efficiently perturb electromagnetic wave patterns within the cavity 28.

As depicted, the microwave system 10 may also include an outer structure or casing 40, which may shield objects from exposure to the electromagnetic waves generated by the magnetron 18. As illustrated, the bracket 14 may be spaced a distance 42 from the wall 16 in order to more efficiently perturb the electromagnetic waves using the electronic mode stirrer assembly 12. Similarly, the platform 34 may be spaced a height 44 from the floor 36. For example, distances 42 and 44 may be approximately one-half of the wavelength of the electromagnetic waves emitted by the magnetron 18, such as approximately 10 cm (2.5 inches). As described in detail below, the electronic mode stirrer assembly 12 may be used to perturb the electromagnetic wave patterns within the cavity 28, thereby ensuring a more uniform heating of objects within the microwave system 10, while doing so in a manner to enhance reliability and simplify manufacturing of the microwave system 10.

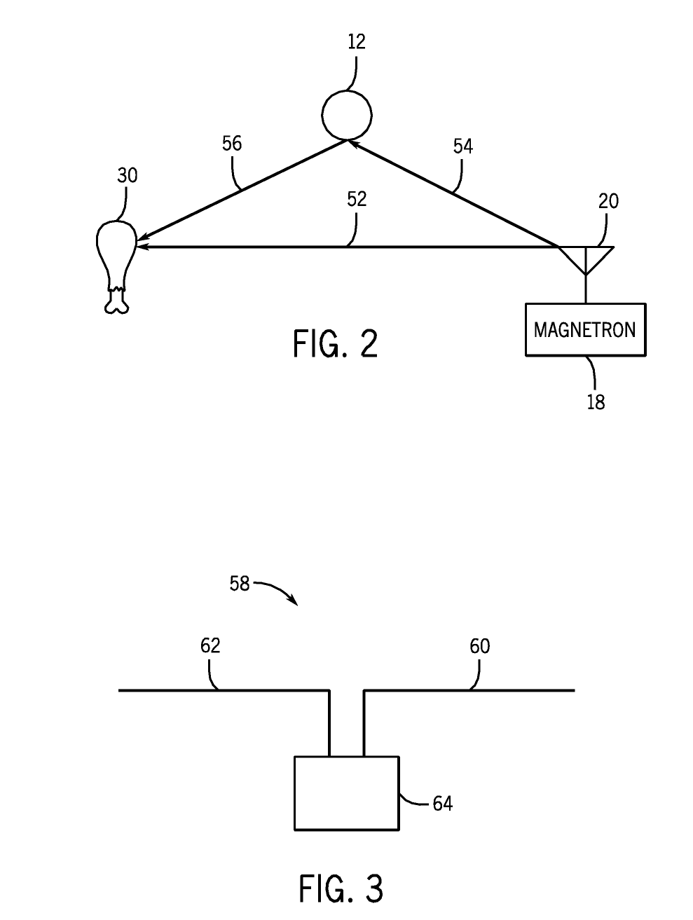

FIG. 2 is a detailed illustration of the electromagnetic waves generated by the magnetron 18 and their relationship with electronic mode stirrer assembly 12. In the diagram of FIG. 2, the magnetron 18 is shown emitting a ray 52 of electromagnetic energy from feeder 20, to a mass 30 located within the microwave system 10. In addition, a ray 54 of electromagnetic energy may encounter the electronic mode stirrer assembly 12. As described in detail below, the electronic mode stirrer assembly 12 includes one or more scatterers with a variable or changing radar cross section, configured to perturb the electromagnetic waves and their patterns within the cavity 28. As depicted, the ray 54 is re-radiated by the electronic mode stirrer assembly 12, which is depicted by a ray 56. Rays 52 and 56 may both encounter the mass 30, wherein the magnitude of the re-radiated magnetic wave in ray 56 is different from the magnitude of the electromagnetic energy of ray 52. Further, the phases of the electromagnetic energy within rays 52 and 56 may differ, enhancing the perturbation of the wave patterns in the microwave cavity 28.

FIG. 3 is a schematic diagram of an exemplary embodiment of a scatterer 58. The scatterer 58 includes conductors 60 and 62, which may be configured to have a relatively small radar cross section at or near the frequency of the electromagnetic energy of ray 56. The conductors 60 and 62 are each coupled to a connector 64. The connector 64 may be configured to connect and disconnect the conductors 60 and 62 when the scatterer 58 is cooled and heated, respectively. For example, the scatterer 58 may receive electromagnetic energy, thereby heating the conductors 60 and 62, causing the connector 64 to disconnect the conductors 60 and 62 due to expansion caused by the heating. Accordingly, the radar cross section of the scatterer 58 is reduced when the conductors 60 and 62 are disconnected. Further, when the scatterer 58 is cooled and the conductors 60 and 62 are disconnected, the cooling of the connector 64 may electrically join the conductors 60 and 62, thereby increasing the radar cross section of the scatterer 58. Therefore, the scatterer 58 may alternate between a relatively small and larger radar cross section as the scatterer 58 is heated and cooled, respectively.

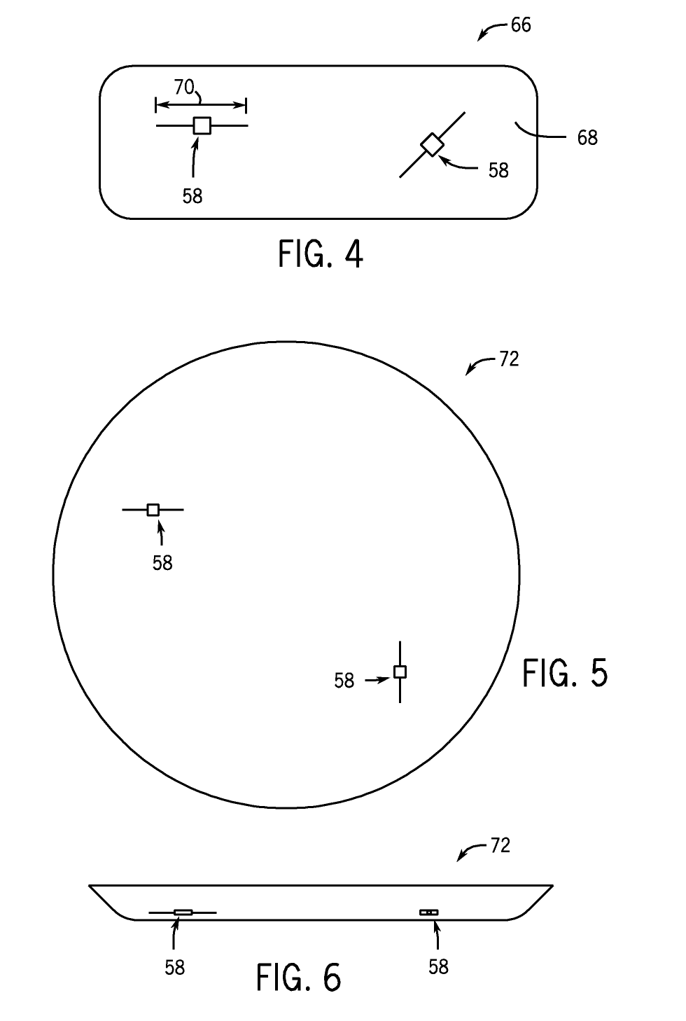

FIG. 4 is top view of an embodiment of an electronic mode stirrer assembly 66. As depicted, the electronic mode stirrer 66 includes a plurality of scatterers 58. The scatterers 58 are configured to be in different rotational orientations with respect to one another. The differing orientations may be used to improve the perturbation of electromagnetic waves by each of the scatterers 58. For example, the electronic mode stirrer assembly 66 may include a tray 68, wherein the scatterers 58 are located on, or embedded in, the tray 68. Further, a piece of food may be placed on the tray 68 inside the microwave cavity 28, to be heated by the microwave system 10. Moreover, the tray 68 may be removed from the microwave to be cleaned and reused for additional heating processes within the microwave system 10.

Alternatively, the assembly 66 may include a structural member 68, which may be included as a portion of bracket 14 and/or platform 34. Specifically, the member 68 may be a component of the platform 34, where a plate of food may be placed for heating by the microwave system 10. A length 70 of the scatterer 58 may be determined in relation to a wavelength of the electromagnetic energy generated by the magnetron 18. Specifically, for optimal perturbation and distribution of the electromagnetic waves, the distance 70 may be between about 25% and about 75% of the wavelength of the electromagnetic waves. For example, for a microwave system 10 that generates waves at a frequency of 2.45 GHz, the wavelength may be approximately 20 cm (5 inches). Accordingly, in the example, the length 70 may be approximately about 5-7.5 cm (2 to 3 inches). Specifically, length 70 may be about 10 cm (2.5 inches).

In another embodiment, the tray 68 may include a single scatterer 58, or two or more scatterers 58. In addition, the tray 68, including a plurality of scatterers 58 may be placed in the microwave system 10 which also includes a plurality of scatterers 58, each coupled to interior portions of the microwave cavity 28. Alternatively, the scatterers 58 may be located on, or embedded in, an adhesive member, such as a sticker, which is able to withstand heating when coupled to a structure that is exposed to electromagnetic waves within the microwave system 10. For example, the sticker, including scatterers 58, may be placed on the wall 16, a plate or the bracket 14 within the microwave cavity 28.

FIG. 5 is a top view of an embodiment of a piece of cookware, such as a plate 72, that includes the scatterers 58. As depicted, two scatterers 58 are located on or embedded in the plate 72. Alternatively, as few as one or as many as ten or more scatterers 58 may be located in the plate 72. The scatterers 58 are arranged in different orientations with respect to one another, thereby increasing the perturbation of electromagnetic waves within the microwave system 10. For example, the scatterers 58 may be on or embedded inside the plate 72, wherein a piece of food or mass 30 may be placed on the plate 72 and heated inside the microwave cavity 28.

As discussed above, the scatterer 58 is configured to vary its radar cross section due to properties and materials of the connector 64, conductors 60 and 62. Specifically, the connector 64 may connect the conductors 60 and 62 as the scatterer 58 cools down, thereby increasing the radar cross section of the scatterer 58. Further, as microwave energy from the magnetron is received by the conductors 60 and 62, the scatterer 58 is heated, thereby expanding the connector 64 to disconnect the conductors 60 and 62 thereby, decreasing the radar cross section of the scatterer 58. As the radar cross section of the scatterer 58 increases and decreases the re-radiation of electromagnetic waves by the scatterer 58 changes, thereby disturbing a wave pattern to vary the distribution of electromagnetic energy, and heat, through the microwave cavity 28. FIG. 6 is a side view of the plate 72 shown in FIG. 5, including a plurality of scatterers 58. As depicted, the scatterers 58 are embedded within the plate 72, which may be placed inside the microwave system 10 for heating of the mass 30 using the scatterers 58 to insure a more uniform heating process.

For the embodiments discussed above, the conductors 60 and 62 may be made of a conductive material such as copper or aluminum. Further, the conductors 60 and 62 may be thin as compared to length 70. For example, in an embodiment where the length 70 is 10 cm (2.5 inches), the conductors 60 and 62 may be about 0.1 inch wide. The connector 64 may be composed of a matrix material, such as a polymer or silicone matrix. The matrix material may have a high thermal coefficient of expansion and may include small metallic grains that are conductive within the matrix. The metallic conductive grains may be composed of copper or zinc. These properties enable the connector 64 to expand and contract to allow the radar cross section of the scatter to vary. Specifically, when the matrix is cooled the metal particles may touch as the matrix contracts, thereby forming an electrical connection between the conductors 60 and 62. When conductors 60 and 62 are electrically connected, the scatterers 58 have a high radar cross section. As electromagnetic waves are received by the conductors 60 and 62, the conductors 60 and 62 are heated, thereby expanding the matrix, causing a disconnect between the adjacent metal particles, which reduces the radar cross section. The alternating high and low radar cross section of the scatterers 58 causes a perturbance in the electromagnetic waves within the microwave cavity 28, thereby distributing the waves more evenly to reduce nulls within the microwave system 10.

Alternatively, the conductors 60 and 62 may be connected by the connector 64 that includes an insulating material located between a pair of conductor plates, where the conductor plates are each coupled to conductor 60 or 62. The conductor plates and insulated dielectric material are located within the connector 64, where the plates function as plates of a capacitor. Accordingly, when current flows through the conductors 60 and 62, the dielectric material is heated causing a separation of one of the plates from the dielectric material. This reduces the capacitive coupling and the current flow through the assembly. According, the radar cross section of the scatterer 58 is reduced. In addition, when the current flow is reduced, the material cools and the previously separated conductor plate comes back into contact with dielectric material, reforming a capacitive coupling of the two conductor plates, thereby providing a conductive path. After cooling, the radar cross section is larger for the assembly, enabling the scatterer to re-radiate the electromagnetic waves, causing a perturbation in the wave patterns within the microwave cavity 28

Technical effects of the invention include reduced complexity in microwave systems and improved heating distribution within microwave cavities. The embodiments enable a perturbation or disruption of microwave patterns within a microwave cavity to reduce or eliminate cold spots or nulls. In addition, the components utilized as a mode stirrer, to perturb wave patterns, may reduce production costs and manufacturing complexity. Further, it may improve reliability and quality by eliminating mechanical parts that may be used for mode stirring assemblies.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a mode stirrer comprising a scatterer with a radar cross section configured to change when exposed to electromagnetic radiation.

2. The system of claim 1, wherein the scatterer comprises conductors coupled to a connector.

3. The system of claim 2, wherein the connector comprises a polymer matrix that includes conductive particles.

4. The system of claim 3, wherein the conductive particles comprise metallic grains.

5. The system of claim 2, wherein the connector comprises a silicone matrix that includes conductive particles.

6. The system of claim 2, wherein a length of the scatterer is between about 25% and about 75% of a wavelength of the electromagnetic radiation.

7. The system of claim 2, wherein the electrical conductors are approximately the same length and are substantially collinear.

8. The system of claim 2, wherein the connector comprises an insulated material located between the electrical conductors.

9. The system of claim 1, comprising a microwave oven, wherein the mode stirrer is disposed within the microwave oven.

10. The system of claim 1, comprising a piece of cookware, wherein the mode stirrer is disposed on or in the cookware.

11. The system of claim 1, comprising a tray for receiving an object to be heated, and wherein the mode stirrer is disposed on or in the tray.

12. The system of claim 1, wherein the mode stirrer comprises a plurality of scatterers.

13. A method, comprising:
emitting electromagnetic radiation from a magnetron;
receiving the electromagnetic waves in a scatterer; and
varying a radar cross section of the scatterer in response to exposure to the electromagnetic radiation.

14. The method of claim 13, wherein varying a radar cross section of the scatterer comprises connecting and disconnecting a plurality of conductors, wherein connecting the conductors comprises cooling a matrix material coupled to each of the conductors, and wherein disconnecting the conductors comprises heating the matrix material.

15. The method of claim 14, wherein the matrix material comprises a polymer matrix with conductive particles.

16. The method of claim 13, wherein a length of the scatterer is between about 25% and about 75% of a wavelength of the electromagnetic radiation.

17. A method, comprising:
coupling a purality of conductors to a connector comprising a matrix that includes conductive particles to form a scatterer assembly; and
coupling the scatterer assembly to a member configured to be exposed to electromagnetic radiation inside a structure.

18. The method of claim 17, wherein coupling the scatterer assembly to a member comprises coupling the scatterer to a wall of the structure.

19. The method of claim 17, wherein coupling the scatterer assembly to a member comprises coupling the scatterer to a piece of cookware that is removable from the structure.

20. The method of claim 17, wherein coupling a plurality of conductors to a connector comprising a matrix that includes conductive particles comprises coupling the conductors to a polymer matrix with metallic particles.

21. The method of claim 17, wherein coupling a plurality of conductors to a connector comprising a matrix that includes conductive particles comprises coupling the conductors and the connector to comprise a length of about 25% to about 75% of a wavelength of the electromagnetic waves.
